(19) United States
(12) Patent Application Publication
(10) Pub. No.: US 2026/0129198 A1
(43) Pub. Date: May 7, 2026

(54) ENCODING AND DECODING METHOD, AND STORAGE MEDIUM

(71) Applicant: GUANGDONG OPPO MOBILE TELECOMMUNICATIONS CORP., LTD., Dongguan (CN)

(72) Inventors: Yue YU, Palo Alto, CA (US); Haoping YU, Palo Alto, CA (US); Jonathan GAN, Palo Alto, CA (US)

(21) Appl. No.: 19/437,574

(22) Filed: Dec. 31, 2025

Related U.S. Application Data
(63) Continuation of application No. PCT/CN2024/103097, filed on Jul. 2, 2024.
(60) Provisional application No. 63/525,114, filed on Jul. 5, 2023.

(51) Int. Cl. H04N 19/119; H04N 19/11; H04N 19/117; H04N 19/159; H04N 19/176; H04N 19/186; H04N 19/80

(52) U.S. Cl. CPC H04N 19/119; H04N 19/11; H04N 19/117; H04N 19/159; H04N 19/176; H04N 19/186; H04N 19/80

(57) ABSTRACT

A method for decoding a video includes (i) determining a partition mode of a current block of the video; (ii) identifying corresponding luma blocks of the current block; and (iii) determining whether one or more of the corresponding luma blocks is coded with a pre-determined mode based on a pre-defined order. In response to a determination that one or more of the corresponding luma blocks is coded with the pre-determined mode, the method further comprises applying the pre-determined mode to a chroma block of the present block.

### CROSS-REFERENCE TO RELATED APPLICATION(S)

This application is a continuation of International Application No. PCT/CN2024/103097, filed Jul. 2, 2024, which claims priority to U.S. Provisional Application No. 63/525,114, filed on Jul. 5, 2023, the entire disclosures of which are incorporated herein by reference.

### TECHNICAL FIELD

The present disclosure relates to imaging and video coding technologies. More particularly, an encoding method, a decoding method, and a storage medium are discussed herein.

### BACKGROUND

Existing video compression methods, such as High Efficiency Video Coding (HEVC) and Versatile Video Coding (VVC) perform blocking and quantization processes when coding. The HEVC and VVC standards specify a block-based, hybrid spatial and temporal predictive coding scheme. During coding, each picture is first divided into square blocks called CTUs (Coding Tree Units). Each CTU in a picture can be partitioned into one or more Coding Units (CUs), which can be used for prediction and transform. A variety of prediction tools may be used, including inter-prediction and intra-prediction tools. When a single-tree partition is used, a chroma component and the corresponding luma component use the same partition. When a dual-tree partition is used, a chroma component and the corresponding luma component can use different partition schemes. Existing methods do not provide tools that can enable effective filtering and fusion schemes for dual-tree partition. Therefore, it is advantageous to have an improved system and method to address the foregoing needs.

### SUMMARY

In a first aspect, a method for decoding a video is provided. The method include the following. A partition mode of a current block of the video is determined. Corresponding luma blocks of a current chroma block are identified. Whether one or more of the corresponding luma blocks is coded with a pre-determined mode is determined based on a pre-defined order. In response to a determination that one or more of the corresponding luma blocks is coded with the pre-determined mode, the pre-determined mode is applied to the current chroma block.

In a second aspect, a method for encoding a video is provided. The method include the following. Determine that a partition mode of a current block is a dual-tree partition. Corresponding luma blocks of a current chroma block are identified. Whether one or more of the corresponding luma blocks is coded with a pre-determined mode is determined based on a pre-defined order. In response to a determination that one or more of the corresponding luma blocks is coded with the pre-determined mode, the pre-determined mode is applied to the current chroma block. The chroma block is processed based on a direct block vector (DBV) chroma reference block.

In a third aspect, a non-transitory computer-readable storage medium is provided. The non-transitory computer-readable storage medium has a computer program and a bitstream stored thereon. When the computer program is executed by a processor, the processor is enabled to perform the encoding method of the second aspect to generate the bitstream.

Other features and aspects of the disclosed features will become apparent from the following detailed description, taken in conjunction with the accompanying drawings, which illustrate, by way of example, the features in accordance with embodiments of the disclosure. The summary is not intended to limit the scope of any embodiments described herein.

### BRIEF DESCRIPTION OF THE DRAWINGS

To describe the technical solutions in the implementations of the present disclosure more clearly, the following briefly describes the accompanying drawings. The accompanying drawings show merely some aspects or implementations of the present disclosure, and a person of ordinary skill in the art may still derive other drawings from these accompanying drawings without creative efforts.

FIG. 1A is a schematic diagram illustrating a system in accordance with one or more implementations of the present disclosure.

FIG. 1B is a schematic diagram illustrating a decoding system in accordance with one or more implementations of the present disclosure.

FIG. 2 is a schematic diagram illustrating IntraTMP processes in accordance with one or more implementations of the present disclosure.

FIG. 3 is a schematic diagram illustrating an intra prediction process in accordance with one or more implementations of the present disclosure.

FIG. 4A is a schematic diagram illustrating an IntraTMP process in a search area in accordance with one or more implementations of the present disclosure.

FIG. 4B is a schematic diagram illustrating an example partitioning of a CTU into CUs in accordance with one or more implementations of the present disclosure.

FIG. 4C is a schematic diagram illustrating slice partitioning in accordance with one or more implementations of the present disclosure.

FIG. 4D is a schematic diagram illustrating tile partitioning in accordance with one or more implementations of the present disclosure.

FIG. 4E is a schematic diagram illustrating dividing a picture into wavefronts in accordance with one or more implementations of the present disclosure.

FIG. 5A is a schematic diagram illustrating checking five corresponding luma blocks for a chroma blocks in accordance with one or more implementations of the present disclosure.

FIG. 5B is a schematic diagram illustrating a prediction process of a DBV (direct block vector) method in accordance with one or more implementations of the present disclosure.

FIG. 6 is a schematic diagram of a wireless communication system in accordance with one or more implementations of the present disclosure.

FIG. 7 is a schematic block diagram of a terminal device in accordance with one or more implementations of the present disclosure.

FIG. 8 is a schematic block diagram of an electronic device in accordance with one or more implementations of the present disclosure.

FIG. 9 is a flowchart of a method in accordance with one or more implementations of the present disclosure.

### DETAILED DESCRIPTION

The present disclosure is related to systems and methods for direct block copy for intra chroma prediction for video coding. More particularly, the present systems and methods enable copying a reference chroma block according to a block vector for corresponding luma block for coding a chroma block. The proposed methods can be used to improve bitstream structure, syntax, constraints, and mapping for generating decoded pictures.

For example, the present systems and methods enable that a direct block vector (DBV) chroma reference block can also be filtered if a corresponding luma block is coded as either a filtered intra-template-matching-prediction (IntraTMP) block or a filtered intra-block-copy (IBC) block.

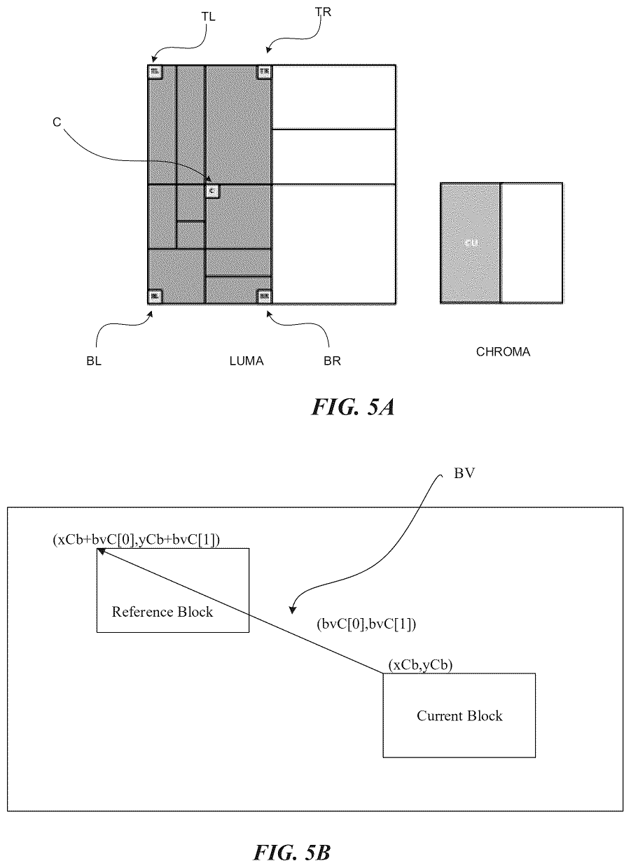

In some embodiments, when a dual-tree partition is enabled for an intra prediction slice, five corresponding luma blocks for a chroma block can be checked according to a pre-defined order. For example, these five corresponding luma blocks can be center (C), top-left (TL), top-right (TR), bottom-left (BL) and bottom-right (BR) blocks. Embodiment of these five corresponding luma blocks are discussed in detail with reference to FIG. 5A.

If any one of these five blocks is coded with either an IBC mode or an IntraTMP mode, the first luma block in the pre-defined order coded with the IBC mode or the IntraTMP mode can be selected as the corresponding luma block, and the current chroma block is eligible for the DBV mode. Once the DBV mode is selected, the block vector (BV) of the corresponding luma block (e.g., the first luma block) can be used to derive a scaled BV according to the chroma format (e.g., “4:2:0”) for the current chroma block. In addition, in some embodiments, the coding mode of the corresponding luma block can be inherited for coding the current chroma block.

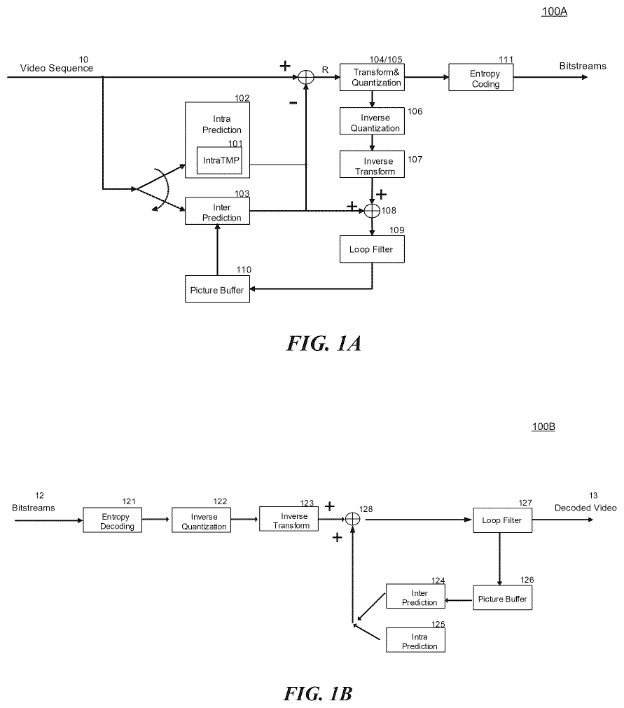

For example, if the corresponding luma block is coded as a filtered IntraTMP or a filtered IBC block, the DBV chroma reference block is also further filtered. Embodiments of the filtering processes are discussed in detail with reference to FIGS. 1A and 1B.

The present disclosure also provides methods for accommodating single-tree partition schemes. When a single-tree partition is enabled for an intra slice, the corresponding luma block can be checked for the current chroma block. If the corresponding luma block is coded with either the IBC mode or the IntraTMP mode, the current chroma block can be coded with a direct mode (DM). The BV of the luma block can be used to derive the scaled BV according to the chroma format (e.g., “4:2:0”) for the current chroma block. In addition, the coding mode of this luma block is inherited for coding the current chroma block. For example, if this luma block is coded as a filtered IntraTMP or a filtered IBC block, a DM chroma reference block can also be further filtered.

In some embodiments, if a luma block was predicted by a filtered IntraTMP block or a filtered IBC block, the filter parameters of the luma block can also be inherited for coding the corresponding chroma block. In some embodiments, if a luma block was predicted by a filtered IntraTMP block or a filtered IBC block, the filter parameters can be derived according to the template of the current chroma block and the template of the DBV or DM reference chroma block indicated by a corresponding parameter (e.g., “bvC” discussed in detail with reference to FIG. 5B).

In some embodiments, if the corresponding luma block is coded with an IntraTMP fusion mode (e.g., “N” luma blocks are fused together to generate a luma prediction block), the coding of the current chroma block can also follow the IntraTMP fusion process to generate a chroma prediction block. More particularly, if “N” luma blocks are used with pre-defined weights, “N” corresponding chroma blocks together with the same weights can also be used to generate the chroma prediction.

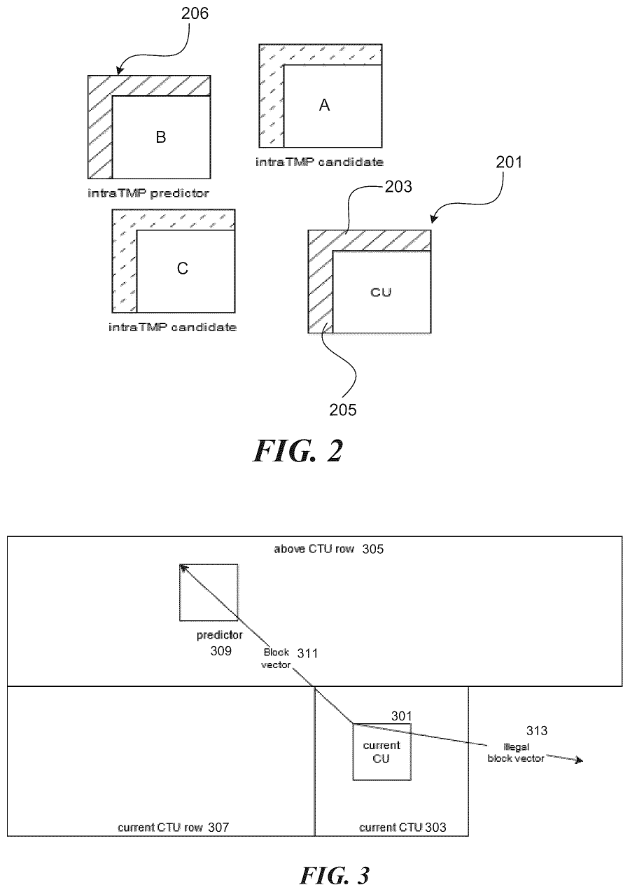

The present disclosure is also related to systems and methods for coding and/or encoding. Intra template matching prediction predicts its current coding unit (CU) by a block of samples from a current picture. During an encoding and/or a decoding process, a coding device (e.g., an encoder or a decoder) compares a pre-defined “L-shaped” or other shaped template of reconstructed samples neighboring the current CU against the same shaped templates of candidate predictors within a pre-determined search region and determines an IntraTMP predictor block. In cases where the template is “L-shaped,” both neighboring samples to the left and above the current CU are used as the template for the current CU. Similarly, neighboring samples to the left and above of candidate predictors are used as the candidate template for each candidate predictor. The IntraTMP predictor block is determined by finding the best candidate template that matches the current CU template. Embodiments of an “L-shaped” template are discussed in detail with reference to FIG. 2. In some embodiments, a different template shape can be used, in which case the different template shape is used as the candidate template for each candidate predictor.

Though the following systems and methods are described in relation to video processing, in some embodiments, the systems and methods may be used for other image processing systems and methods. The present disclosure also provides a framework/network that can be trained by deep learning and/or artificial intelligent schemes.

In some embodiments, the methods discussed herein for a “picture” or a “frame” can be applied to a portion or a region of the “picture” or the “frame.” For example, the methods disclosed herein can be applied to a sub-picture, a region of a picture (e.g., showing an object of interest), etc.

In some embodiments, the present method can be implemented by a tangible, non-transitory, computer-readable medium having processor instructions stored thereon that, when executed by one or more processors, cause the one or more processors to perform one or more aspects/features of the method described herein. In other embodiments, the present method can be implemented by a system comprising a computer processor and a non-transitory computer-readable storage medium storing instructions that when executed by the computer processor cause the computer processor to perform one or more actions of the method described herein.

To describe the technical solutions in the implementations of the present disclosure more clearly, the following briefly describes the accompanying drawings. The accompanying drawings show merely some aspects or implementations of the present disclosure, and a person of ordinary skill in the art may still derive other drawings from these accompanying drawings without creative efforts.

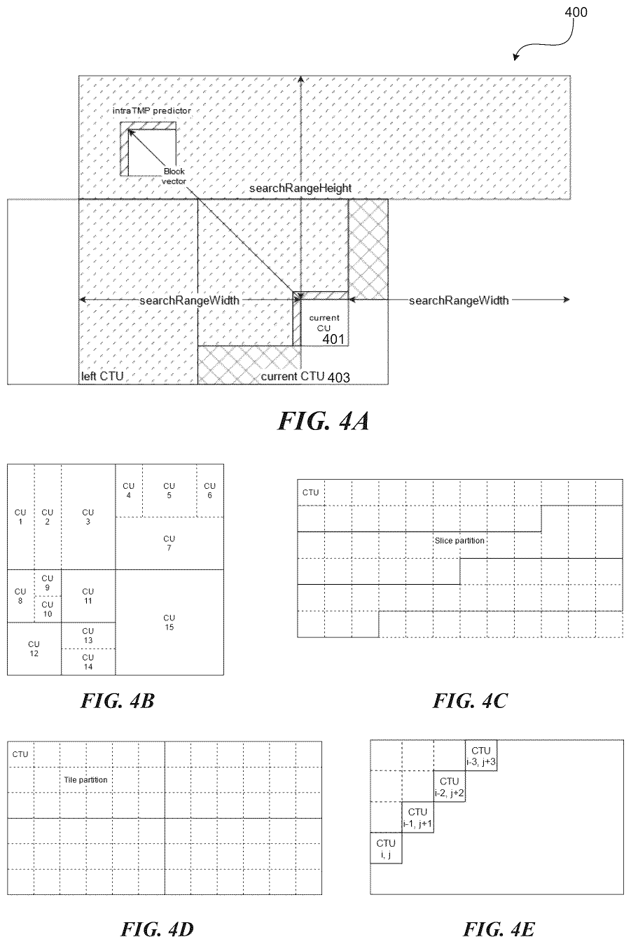

FIG. 1A is a schematic diagram illustrating a system 100A having an IntraTMP module 101 (in an intra prediction module 102) in accordance with one or more implementations of the present disclosure. The IntraTMP module 101 is configured to perform a template search process in a search area (e.g., FIG. 2 and FIG. 4A). In some embodiments, in addition to the IntraTMP module 101, the intra prediction module 102 can also include other intra-prediction modules/tools, such as IBC (Intra Block Copy), SGPM (Spatial Geometric Partitioning Mode), MIP (Matrix-based Intra Prediction), regular angular intra prediction tools, etc.

The system 100A includes a video sequence 10 as input to the intra prediction module 102 and/or an inter prediction module 103. The output of the intra prediction module 102 and/or the inter prediction module 103 can be subtracted from a current CU of the video sequence 10 to generate a residual R. Then the residual R can be directed to a transform module 104. The output of the transform module 104 can be quantized by a quantization module 105. The output of the quantization module 105 can then be directed to an inverse quantization module 106 and an inverse transform module 107.

As shown in FIG. 1A, at an adder 108, the output of the intra prediction module 102 and/or the inter prediction module 103 can be added with the output of the inverse transform module 107. The added result can then be directed to an in-loop filter 109. The output of the in-loop filter 109 can then be directed to a decoded picture buffer 110 for further processes by the inter prediction module 103. The system 100A uses loop filters to suppress compression artifacts and reduce distortion. These loop filters include a deblocking filter (DBF), a sample adaptive offset (SAO) filter, and an adaptive loop filter (ALF). In some embodiments, the in-loop filter 109 is not required to include all of the filters described above. In some embodiments, the DBF and the SAO filter are two filters designed to reduce artifacts caused by an encoding process. The DBF focuses on visual artifacts at block boundaries. The SAO filter complementarily reduces artifacts that may arise from quantization of transform coefficients within blocks. The ALF can enhance an adaptive filter of a reconstructed signal, reducing a mean square error (MSE) between the original and reconstructed samples by using a Wiener-based adaptive filter. The system 100A also includes an entropy coding module 111 configured to perform data compression before generating a bitstream 11.

### Direct Block Vector (DBV) Mode-Dual Tree Partition

The intra prediction module 102 is configured to enable copying a reference chroma block according to a block vector for corresponding luma block for coding a chroma block. For example, the intra prediction module 102 enables that a direct block vector (DBV) chroma reference block can also be filtered if a corresponding luma block is coded as either a filtered IntraTMP block or a filtered IBC block.

In some embodiments, when a dual-tree partition is enabled for an intra prediction slice, several (e.g., five) corresponding luma blocks for a chroma block can be checked according to a pre-defined order. For example, these five corresponding luma blocks can be center (C), top-left (TL), top-right (TR), bottom-left (BL) and bottom-right (BR) blocks, as shown in FIG. 5A. In some embodiments, the pre-defined order can be from center (C), top-left (TL), top-right (TR), bottom-left (BL) and then bottom-right (BR).

In some embodiments, if any one of these five blocks is coded with either an IBC mode or an IntraTMP mode, the first luma block in the pre-defined order coded with the IBC mode or the IntraTMP mode can be selected as the corresponding luma block, and the current chroma block is eligible for the DBV mode. In other embodiments, suitable modes other than the IBC mode and the IntraTMP mode can also be identified and processed in the foregoing manner.

Once the DBV mode is selected, the block vector (BV) of the corresponding luma block (e.g., the first luma block) can be used to derive a BV for the current chroma block according to the chroma format (e.g., “4:2:0”). In addition, in some embodiments, the coding mode of the corresponding luma block can be inherited for coding the current chroma block. For example, if the corresponding luma block is coded as a filtered IntraTMP or a filtered IBC block, the DBV chroma reference block is also further filtered.

### Direct Mode (DM)-Single Tree Partition

The intra prediction module 102 is also configured to accommodate single-tree partition schemes. For example, when intra prediction module 102 determines that a single-tree partition is enabled for an intra slice, the corresponding luma block can be checked for the current chroma block. If the corresponding luma block is coded with either the IBC mode or the IntraTMP mode (or other suitable modes), the current chroma block can be coded with a direct mode (DM). The BV of the luma block can be used to derive the BV for the current chroma block according to the chroma format (e.g., “4:2:0”). In addition, the coding mode of this luma block is inherited for coding the current chroma block. For example, if this luma block is coded as a filtered IntraTMP or a filtered IBC block, a DM chroma reference block can also be further filtered.

In some embodiments, if a luma block was predicted by a filtered IntraTMP block or a filtered IBC block, the filter parameters of the luma block can also be inherited for coding the corresponding chroma block. In some embodiments, if a luma block was predicted by a filtered IntraTMP block or a filtered IBC block, the filter parameters can be derived according to the template of the current chroma block and the template of the DBV or DM reference chroma block indicated by a corresponding parameter (e.g., “bvC” discussed in detail with reference to FIG. 5B).

In some embodiments, if the corresponding luma block is coded with an IntraTMP fusion mode (e.g., “N” luma blocks are fused together to generate a luma prediction block), the coding of the current chroma block can also follow the IntraTMP fusion process to generate a chroma prediction block. More particularly, if “N” luma blocks are used with pre-defined weights, “N” corresponding chroma blocks together with the same weights can also be used to generate the chroma prediction.

FIG. 1B is a schematic diagram illustrating a decoding system 100B having an IntraTMP module in accordance with one or more implementations of the present disclosure. The system 100B includes an entropy decoding module 31, an inverse quantization module 122, and an inverse transform module 123 configured to process a bitstream 12. The decoding system 100B also includes an inter prediction module 124 and an intra prediction module 125 (e.g., corresponding to the intra prediction module 102 at the encoding side). The inter prediction module 124 and the intra prediction module 125 are configured to process the bitstream 12 and generate a decoded video 13. The intra prediction module 125 can perform functions similar to the intra prediction module 102 discussed above but at the decoding side.

As shown in FIG. 1B, the decoding system 100B also includes a picture buffer 126 and a loop filter 127 to facilitate the foregoing decoding tasks. As shown in FIG. 1B, at an adder 128, the output of the intra prediction module 125 and/or the inter prediction module 124 can be added with the output of the inverse transform module 123. The added result can then be directed to the loop filter 127 so as to generate the decoded video 13.

FIG. 2 is a schematic diagram illustrating a candidate predictor 201 for a coding unit (CU) for an IntraTMP process in accordance with one or more implementations of the present disclosure. As shown in FIG. 2, the candidate predictor 201 includes a first region 203 upper to the CU and a second region 205 left to the CU. The first region 203 and the second region 205 form an “L-shape.” In some embodiments, the candidate predictor 201 can be in other shapes (e.g., including either one of the first region 203 and the second region 205). The candidate predictor 201 is configured to be used to search a matching candidate MC from multiple candidates (e.g., candidates A, B, and C as shown in FIG. 2) in a search area (e.g., a current CTU, a reconstructed area, etc.). In the illustrated embodiments, candidate B is selected as the matching candidate. The IntraTMP process then uses the data (e.g., pixels) surround by the candidate predictor 206 as reference data for the CU.

In some embodiments, the best candidate template can be determined by finding the template that minimizes the sum of absolute differences (SAD), or the sum of absolute transformed differences (SATD), or by comparing hashes between templates. In some embodiments, some search algorithms can be used. In some embodiments, the search algorithms through the pre-determined search region can be exhaustive (e.g., by scanning the template over the search region with sample-resolution shifts), or fast (e.g., by performing a coarse search first, then performing a local refinement search around the best match from the coarse search). The search algorithms can be performed identically by both an encoder and a decoder so that the IntraTMP predictor is implicitly known by both the encoder and decoder without requiring signaling in the bitstream.

FIG. 3 is a schematic diagram illustrating an intra prediction process in accordance with one or more implementations of the present disclosure. In the embodiments, an example search area for an intra-block copy (IBC) tool is illustrated. As shown, in the example of FIG. 3 the intra-block copy process may search a current CTU row 307 that has already been decoded, and an above CTU row 305. In the illustrated embodiment, for example, a predictor block 309 is indicated in the above CTU row 305. The predictor block 309 can be indicated by a block vector 311, which points from the top-left corner of the current CU 301 to the top-left corner of predictor block 309. Certain block vectors are not “legal” if they point to an area that is not available, such as an area that has not yet been decoded. For example, an illegal block vector 313 shown in FIG. 3 points at an area following the current CU 301 in decoding order.

In some embodiments, the block vector 311 can be signalled to indicate which block within the same picture will be copied to serve as a predictor for the current block. Signalling of the block vector 311 can be performed by signalling a block vector difference (BVD) in a bitstream, such that the block vector 311 can be determined by adding the BVD to a block vector predictor. In some embodiments, if a block vector from a previous CU is an exact match for a current block vector, it can be signalled by a merge flag.

As shown, the block vector 311 points at a location within the same picture to indicate a block of samples equal in size to the current CU 301 that is used as a predictor block 309 for the current CU 301. In some embodiments, some restrictions can apply to the block vector 311. For example, the block vector 311 must point at a block of samples in the current picture that are available for intra prediction. As another example, the block vector can be restricted to a search region defined by a search tool (e.g., an intra-block copy (IBC) tool) which can be smaller than the current picture. For example, in VVC, the IBC search region is the current CTU and the previous CTU. In some embodiments, IBC search region can be the current CTU row and the above CTU row when the CTU size is 256×256, or the current CTU row and the above 2 CTU rows when the CTU size is 128×128 or smaller. In some embodiments, the present system can perform an IntraTMP process while additionally restricting the IntraTMP search area to the search area of an existing tool (such as the IBC tool) for alignment of buffering requirements.

FIG. 4A is a schematic diagram illustrating a search sequence of an IntraTMP process in a search area 400 in accordance with one or more implementations of the present disclosure. The search area 400 is determined by imposing a maximum length on IntraTMP block vectors, which as shown in FIG. 4A is a vector pointing from the top-left corner of the current CU to the top-left corner of the IntraTMP predictor. The maximum length of an IntraTMP block vector is (searchRangeWidth, searchRangeHeight), which is a maximum of searchRangeWidth horizontally and a maximum of searchRangeHeight vertically. The values of searchRangeWidth and searchRangeHeight are determined as a function of the current CU's width BlkW and height BlkH. For example, in one embodiment, they may be determined by following equations (A) and (B).

searchRangeWidth=max(a*BlkW,minSearchRange) (A)

searchRangeHeight=max(a*BlkH,minSearchRange) (B)

In equations (A) and (B), “max (x, y)” returns the maximum value between “x” and “y.”

In some embodiments, in Equations A and B, “a” can be set as “5” and “minSearchRange” can be set as “128.” In other embodiments, different values of “a” and “minSearchRange” may be used.

Let the top-left corner of the current CU be denoted by a coordinate position (currCuX, currCuY) within a coordinate system where (0, 0) refers to the top-left corner of the picture and increasing coordinate position horizontally and vertically indicates directions to the right and down respectively. Parameter “currCuX” refers to the horizontal position and currCuY refers to the vertical position. Then in this coordinate system the top-left corner of the search area 400 is located at (currCuX−searchRangeWidth, currCuY−searchRangeHeight). The top-right corner of the search area 400 is located at (currCuX+BlkW−1+searchRangeWidth, currCuY-searchRangeHeight). The bottom-left corner of the search area 400 may notionally be located at (currCuX−searchRangeWidth, currCuY+BlkH−1+searchRangeHeight).

In the example of FIG. 4A, the bottom-left corner is limited by the bottom boundary of the left CTU. The bottom-right corner of the search area 400 may notionally be located at (currCuX+BlkW−1+searchRangeWidth, currCuY+BlkH−1+searchRangeHeight). IntraTMP block vectors that point both to the right and down are not possible since they refer to areas of the picture that follow the current CU in coding order. The bottom-right boundary of the search area 400 depends on the availability of samples.

Before limitations due to availability of samples, the search area 400 described above is a notional rectangle. In this disclosure, the search area 400 is defined such that the block of samples corresponding to any IntraTMP predictor must be fully contained within the search area 400. It may be understood that equivalent search areas can be defined according to the nature of the object(s) that must fit within the search area. For example, if the coordinate pointed to by an IntraTMP block vector must be fully contained within the search area, then a smaller but equivalent search area is defined with the top-left, top-right, bottom-left and bottom-right corners at (currCuX−searchRangeWidth, currCuY−searchRangeHeight), (currCuX+searchRangeWidth, curCuY−searchRangeHeight), (currCuX−searchRangeWidth, currCuY+searchRangeHeight), and (currCuX+searchRangeWidth, currCuY+searchRangeHeight) respectively.

In another example, if the block of samples corresponding to any IntraTMP predictor and its template must be fully contained within the search area, then a larger but equivalent search area is defined with the top-left, top-right, bottom-left and bottom-right corners at (currCuX−searchRangeWidth−templateWidth, currCuY−searchRangeHeight−templateHeight), (currCuX+BlkW−1+searchRangeWidth, currCuY−searchRangeHeight−templateHeight), (currCuX−searchRangeWidth−templateWidth, currCuY+BlkH−1+searchRangeHeight), and (currCuX+BlkW−1+searchRangeWidth, currCuY+BlkH−1+searchRangeHeight) respectively, where templateWidth and templateHeight refer to the dimensions of the template shape. It may be understood that variations in the definition of the search area do not affect the operation of the IntraTMP search algorithm described in this disclosure.

The search area 400 is further limited from the notional rectangle described above due to availability of samples. Availability of samples depends on two factors: firstly, whether the samples have already been reconstructed, and secondly, whether the samples belong to a logical unit that the current CU is permitted to use.

To determine whether samples have already been reconstructed we consider the partitioning structure of VVC. Each picture is divided into a tiling of square CTUs which are processed in raster scan order. When an intra prediction method is performed on a current CU 401 in a current CTU 403, samples belonging to other CTUs preceding the current CTU 403 in raster scan order are reconstructed and may be available for prediction. Samples belonging to CTUs following the current CTU 403 in raster scan order are not reconstructed and therefore not available.

Each CTU itself is partitioned into CUs by a hierarchical structure consisting of quadtree, binary tree, and ternary tree splits, with an example of such splits shown in FIG. 4B. FIG. 4B is a schematic diagram illustrating an example partitioning of a CTU into CUs in accordance with one or more implementations of the present disclosure. The scan order of CUs within a CTU is determined by the partitioning structure. For a single level of partitioning split, the partitions are scanned in the following order:
[1] Left to right for the cases of horizontal binary tree split or horizontal ternary tree split.
[2] Top to bottom for the cases of vertical binary tree split or vertical ternary tree split.
[3] Top-left, top-right, bottom-left, bottom-right for the case of quadtree split.

If a partition contains further hierarchical splits, then all CUs within that partition are scanned before continuing to the CUs in the next partition. FIG. 4B shows an example partitioning of a CTU into 15 CUs, numbered from 1 to 15 to indicate their scan order. When an intra prediction method is performed on a current CU in a current CTU, samples belonging to other CUs in the current CTU which precede the current CU in the current CTU's partitioning scan order are reconstructed and may be available for prediction. Samples belonging to the current CU, or CUs following the current CU in the current CTU's partitioning scan order are not reconstructed and therefore not available.

Samples belonging to a CTU preceding the current CTU in raster scan order are considered reconstructed by the definition above. However, they are not necessarily available for intra prediction. To be considered available for prediction, they must also belong to a logical unit that the current CU is permitted to use. Pictures may be divided into sub-picture partitions, each of which contains a whole number of CTUs. FIG. 4C shows an example where the picture is divided into multiple slices. Samples belonging to a slice other than the slice containing the current CU are not available for intra prediction. Imposing this restriction allows slices to be decoded independently.

FIG. 4D is a schematic diagram illustrating tile partitioning in accordance with one or more implementations of the present disclosure. FIG. 4D shows an example where the picture is divided into multiple tiles. Samples belonging to a tile other than the tile containing the current CU are not available for intra prediction. Imposing this restriction allows tiles to be decoded independently.

FIG. 4E shows an example where a picture is divided into wavefronts. Each wavefront corresponds to a row of CTUs, with dependency between the CTU rows reduced so that each wavefront can be decoded in parallel in a staggered fashion. In the example of FIG. 4E, the wavefronts are processed with a delay of 1 CTU. Let us refer to the CTUs by their position in the grid, such that CTU_(i, j) indicates the CTU located at the i\hat{ }th CTU row and j\hat{ }th CTU column. Then when wavefront parallel processing is enabled by setting an SPS syntax element “sps_entropy_coding_sync_enabled_flag,” a CTU_(a, b) is not available if its CTU column position is greater than the current CTU_(i,j) (i.e., if b>j).

How an intra prediction method deals with unavailability of reference samples needed for prediction varies depending on the method. The method may simply be disabled when such samples are not available. Alternatively, some extrapolation of the unavailable samples may be performed, such as by boundary extension.

FIG. 5A is a schematic diagram illustrating checking five corresponding luma blocks for a chroma blocks in accordance with one or more implementations of the present disclosure. FIG. 5A illustrates a dual-tree mode partition. In the illustrated embodiment, the entire luma tree of luma CUs is decoded before the chroma tree is decoded. Therefore, information such as the selected luma intra prediction mode of the co-located luma CU is available when the chroma intra prediction mode of a chroma CU is determined. A direct block vector (DBV) flag may be signaled to indicate that the chroma CU copies the IntraTMP or IBC block vector of the co-located luma CU and scales this luma block vector (BV) according to the chroma format (e.g., “4:2:0”) to obtain the chroma BV. The chroma BV is then used to copy the reference chroma block from the previous decoded chroma area. Similarly, in single-tree partition cases, a direct mode (DM) flag can be signaled to indicate that the chroma CU copies the block vector of the co-located luma CU and scales this luma BV according to the chroma format (e.g., “4:2:0”) to obtain the chroma BV. The chroma BV is then used to copy the reference chroma block from the previous decoded chroma area.

As shown in FIG. 5A, five corresponding luma blocks for a chroma block can be checked according to a pre-defined order. For example, these five corresponding luma blocks can be center (C), top-left (TL), top-right (TR), bottom-left (BL) and bottom-right (BR) blocks, as shown in FIG. 5A. In some embodiments, the pre-defined order can be from center (C), top-left (TL), top-right (TR), bottom-left (BL) and then bottom-right (BR).

In some embodiments, if any one of these five blocks is coded with either an IBC mode or an IntraTMP mode, the first luma block in the pre-defined order coded with the IBC mode or the IntraTMP mode may be selected as the corresponding luma block, and the current chroma block is eligible for the DBV mode. In other embodiments, suitable modes other than the IBC mode and the IntraTMP mode may also be identified and processed in the foregoing manner.

Once the DBV mode is selected, the block vector (BV) of the corresponding luma block (e.g., the first luma block) may be used to derive a BV for the current chroma block. In addition, in some embodiments, the coding mode of the corresponding luma block can be inherited for coding the current chroma block. For example, if the corresponding luma block is coded as a filtered IntraTMP or a filtered IBC block, the DBV chroma reference block may be also further filtered.

FIG. 5B is a schematic diagram illustrating a prediction process of a DBV (direct block vector) method in accordance with one or more implementations of the present disclosure. BV of a selected luma block (e.g., the first luma block) can be noted as “bvL.” The selected luma block can be coded with either the IBC or IntraTMP mode. The BV “bvL” can be used to derive a BV for the current chroma block, namely “bvC” where bvC[0] and bvC[1] represent the pixel displacements along horizontal and vertical directions relative to the top-left corner of the current chroma block, respectively. In some embodiments, “bvC” may be derived by scaling “bvL” by the chroma sampling ratio. For example, when the chroma format is 4:2:0 which indicates that the chroma components are subsampled by 2 times in both the vertical and horizontal directions, “bvC” may be obtained by “0.5*bvL.”

In some embodiments, the reference chroma block indicated by the derived “bvC” can be directly copied to predict the current chroma block as shown in FIG. 5B. Suppose that the coordinates of the top-left corner of the current chroma block are (xCb, yCb). The reference chroma block refers to the same size block whose coordinates of the top-left corner can be (xCb+bvC[0], yCb+bvC[1]).

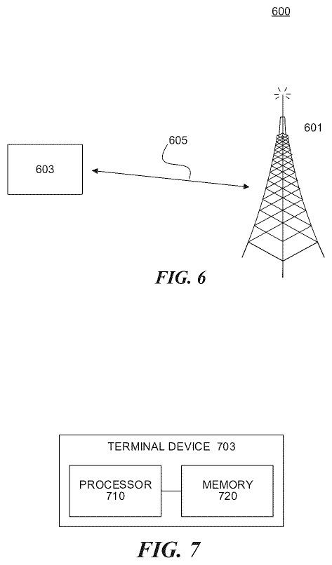

FIG. 6 is a schematic diagram of a wireless communication system 600 in accordance with one or more implementations of the present disclosure. The wireless communication system 600 can implement the framework discussed herein. As shown in FIG. 6, the wireless communications system 600 can include a network device (or base station) 601. Examples of the network device 601 include a base transceiver station (Base Transceiver Station, BTS), a NodeB (NodeB, NB), an evolved Node B (eNB or eNodeB), a Next Generation NodeB (gNB or gNode B), a Wireless Fidelity (Wi-Fi) access point (AP), etc. In some embodiments, the network device 601 can include a relay station, an access point, an in-vehicle device, a wearable device, and the like. The network device 601 can include wireless connection devices for communication networks such as: a Global System for Mobile Communications (GSM) network, a Code Division Multiple Access (CDMA) network, a Wideband CDMA (WCDMA) network, an LTE network, a cloud radio access network (Cloud Radio Access Network, CRAN), an Institute of Electrical and Electronics Engineers (IEEE) 802.11-based network (e.g., a Wi-Fi network), an Internet of Things (IoT) network, a device-to-device (D2D) network, a next-generation network (e.g., a 5G network), a future evolved public land mobile network (Public Land Mobile Network, PLMN), or the like. A 5G system or network can be referred to as a new radio (New Radio, NR) system or network.

In FIG. 6, the wireless communications system 600 also includes a terminal device 603. The terminal device 603 can be an end-user device configured to facilitate wireless communication. The terminal device 603 can be configured to wirelessly connect to the network device 601 (e.g., via a wireless channel 605) according to one or more corresponding communication protocols/standards. The terminal device 603 may be mobile or fixed. The terminal device 603 can be a user equipment (UE), an access terminal, a user unit, a user station, a mobile site, a mobile station, a remote station, a remote terminal, a mobile device, a user terminal, a terminal, a wireless communications device, a user agent, or a user apparatus. Examples of the terminal device 603 include a modem, a cellular phone, a smartphone, a cordless phone, a Session Initiation Protocol (SIP) phone, a wireless local loop (WLL) station, a personal digital assistant (PDA), a handheld device having a wireless communication function, a computing device or another processing device connected to a wireless modem, an in-vehicle device, a wearable device, an Internet-of-Things (IoT) device, a device used in a 5G network, a device used in a public land mobile network, or the like.

For illustrative purposes, FIG. 6 illustrates only one network device 601 and one terminal device 603 in the wireless communications system 600. However, in some instances, the wireless communications system 600 can include additional network device 601 and/or terminal device 603.

FIG. 7 is a schematic block diagram of a terminal device 703 (e.g., which can implement the methods discussed herein) in accordance with one or more implementations of the present disclosure. As shown, the terminal device 703 includes a processor 710 and a memory 720. The processor 710 can be configured to implement instructions that correspond to the methods discussed herein and/or other aspects of the implementations described above. It should be understood that the processor 710 in the implementations of this technology may be an integrated circuit chip and has a signal processing capability. During implementation, the steps in the foregoing method may be implemented by using an integrated logic circuit of hardware in the processor 710 or an instruction in the form of software. The processor 710 may be a general-purpose processor, a digital signal processor (DSP), an application specific integrated circuit (ASIC), a field programmable gate array (FPGA) or another programmable logic device, a discrete gate or transistor logic device, and a discrete hardware component. The methods, steps, and logic block diagrams disclosed in the implementations of this technology may be implemented or performed. The general-purpose processor 710 may be a microprocessor, or the processor 710 may be alternatively any conventional processor or the like. The steps in the methods disclosed with reference to the implementations of this technology may be directly performed or completed by a decoding processor implemented as hardware or performed or completed by using a combination of hardware and software modules in a decoding processor. The software module may be located at a random-access memory, a flash memory, a read-only memory, a programmable read-only memory or an electrically erasable programmable memory, a register, or another mature storage medium in this field. The storage medium is located at a memory 720, and the processor 710 reads information in the memory 720 and completes the steps in the foregoing methods in combination with the hardware thereof.

It may be understood that the memory 720 in the implementations of this technology may be a volatile memory or a non-volatile memory, or may include both a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM) or a flash memory. The volatile memory may be a random-access memory (RAM) and is used as an external cache. For exemplary rather than limitative description, many forms of RAMs can be used, and are, for example, a static random-access memory (SRAM), a dynamic random-access memory (DRAM), a synchronous dynamic random-access memory (SDRAM), a double data rate synchronous dynamic random-access memory (DDR SDRAM), an enhanced synchronous dynamic random-access memory (ESDRAM), a synchronous link dynamic random-access memory (SLDRAM), and a direct Rambus random-access memory (DR RAM). It should be noted that the memories in the systems and methods described herein are intended to include, but are not limited to, these memories and memories of any other suitable type. In some embodiments, the memory may be a non-transitory computer-readable storage medium that stores instructions capable of execution by a processor.

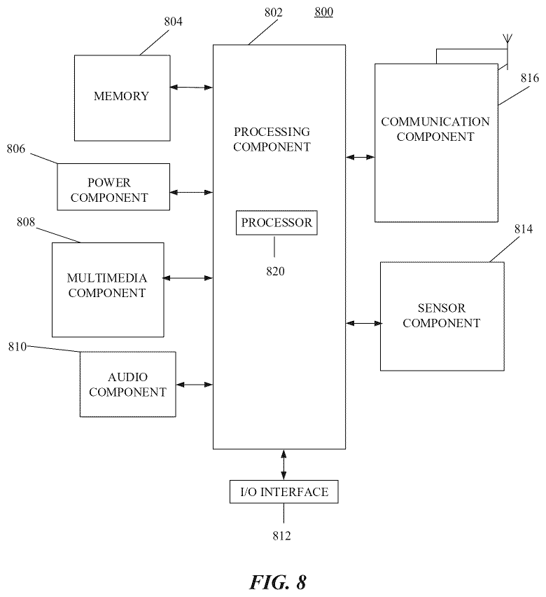

FIG. 8 is a schematic block diagram of an electronic device 800 in accordance with one or more implementations of the present disclosure. The electronic device 800 may include one or more following components: a processing component 802, a memory 804, a power component 806, a multimedia component 808, an audio component 810, an Input/Output (I/O) interface 812, a sensor component 814, and a communication component 816.

The processing component 802 typically controls overall operations of the electronic device, such as the operations associated with display, telephone calls, data communications, camera operations, and recording operations. The processing component 802 may include one or more processors 820 to execute instructions to perform all or part of the steps in the abovementioned method. Moreover, the processing component 802 may include one or more modules which facilitate interaction between the processing component 802 and the other components. For instance, the processing component 802 may include a multimedia module to facilitate interaction between the multimedia component 808 and the processing component 802.

The memory 804 is configured to store various types of data to support the operation of the electronic device. Examples of such data include instructions for any application programs or methods operated on the electronic device, contact data, phonebook data, messages, pictures, video, etc. The memory 804 may be implemented by any type of volatile or non-volatile memory devices, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, and a magnetic or optical disk.

The power component 806 provides power for various components of the electronic device. The power component 806 may include a power management system, one or more power supplies, and other components associated with generation, management and distribution of power for the electronic device.

The multimedia component 808 may include a screen providing an output interface between the electronic device and a user. In some embodiments, the screen may include a Liquid Crystal Display (LCD) and a Touch Panel (TP). If the screen may include the TP, the screen may be implemented as a touch screen to receive an input signal from the user. The TP may include one or more touch sensors to sense touches, swipes and gestures on the TP. The touch sensors may not only sense a boundary of a touch or swipe action but also detect a duration and pressure associated with the touch or swipe action. In some embodiments, the multimedia component 808 may include a front camera and/or a rear camera. The front camera and/or the rear camera may receive external multimedia data when the electronic device is in an operation mode, such as a photographing mode or a video mode. Each of the front camera and the rear camera may be a fixed optical lens system or have focusing and optical zooming capabilities.

The audio component 810 is configured to output and/or input an audio signal. For example, the audio component 810 may include a Microphone (MIC), and the MIC is configured to receive an external audio signal when the electronic device is in the operation mode, such as a call mode, a recording mode and a voice recognition mode. The received audio signal may further be stored in the memory 804 or sent through the communication component 816. In some embodiments, the audio component 810 further may include a speaker configured to output the audio signal.

The I/O interface 812 provides an interface between the processing component 802 and a peripheral interface module, and the peripheral interface module may be a keyboard, a click wheel, a button and the like. The button may include, but not limited to: a home button, a volume button, a starting button and a locking button.

The sensor component 814 may include one or more sensors configured to provide status assessment in various aspects for the electronic device. For instance, the sensor component 814 may detect an on/off status of the electronic device and relative positioning of components, such as a display and small keyboard of the electronic device, and the sensor component 814 may further detect a change in a position of the electronic device or a component of the electronic device, presence or absence of contact between the user and the electronic device, orientation or acceleration/deceleration of the electronic device and a change in temperature of the electronic device. The sensor component 814 may include a proximity sensor configured to detect presence of an object nearby without any physical contact. The sensor component 814 may also include a light sensor, such as a Complementary Metal Oxide Semiconductor (CMOS) or Charge Coupled Device (CCD) image sensor, configured for use in an imaging application. In some embodiments, the sensor component 814 may also include an acceleration sensor, a gyroscope sensor, a magnetic sensor, a pressure sensor or a temperature sensor.

The communication component 816 is configured to facilitate wired or wireless communication between the electronic device and other equipment. The electronic device may access a communication-standard-based wireless network, such as a WIFI network, a 2nd-Generation (2G) or 3G network or a combination thereof. In an exemplary embodiment, the communication component 816 receives a broadcast signal or broadcast associated information from an external broadcast management system through a broadcast channel. In an exemplary embodiment, the communication component 816 further may include a Near Field Communication (NFC) module to facilitate short-range communication. For example, the NFC module may be implemented on the basis of a Radio Frequency Identification (RFID) technology, an Infrared Data Association (IrDA) technology, an Ultra-WideBand (UWB) technology, a Bluetooth (BT) technology and another technology.

In an exemplary embodiment, the electronic device 800 may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, microprocessors or other electronic components, and is configured to execute the abovementioned method.

In an exemplary embodiment, there is also provided a non-transitory computer-readable storage medium including an instruction, such as the memory 804 including an instruction, and the instruction may be executed by the processing component 802 of the electronic device 800 to implement the methods discussed herein. For example, the non-transitory computer-readable storage medium may be a ROM, a Random Access Memory (RAM), a Compact Disc Read-Only Memory (CD-ROM), a magnetic tape, a floppy disc, an optical data storage device and the like.

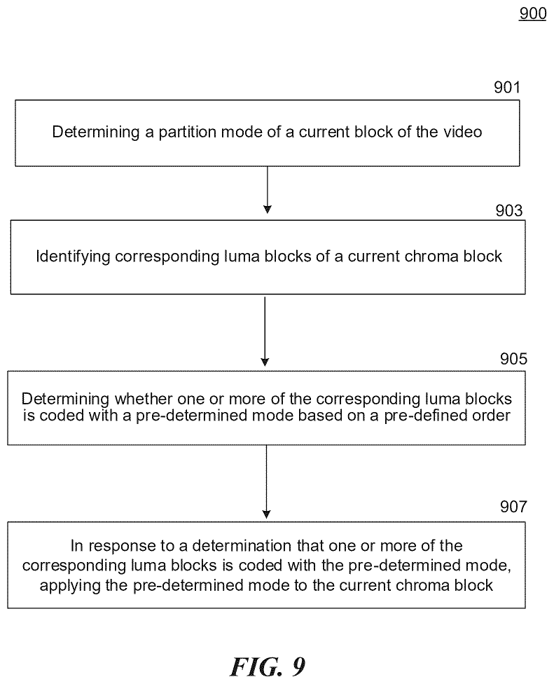

FIG. 9 is a flowchart of a method in accordance with one or more implementations of the present disclosure. The method 900 can be implemented by a system or an apparatus (such as a system or an apparatus having an intra prediction module discussed herein). The method 900 is for processing a video. The method 900 can includes, at block 901, determining a partition mode of a current block of the video. In some embodiments, the partition mode can be a dual-tree partition mode or a single-tree partition mode.

At block 903, the method 900 includes identifying corresponding luma blocks of a current chroma block. At block 905, the method 900 continues by determining whether one or more of the corresponding luma blocks is coded with a pre-determined mode based on a pre-defined order. At block 907, the method 900 continues by, in response to a determination that one or more of the corresponding luma blocks is coded with the pre-determined mode, applying the pre-determined mode to the current chroma block.

In some embodiments, the method 900 can further include (1) determining that the partition mode of the current block is a dual-tree partition; and (2) processing the chroma block based on a direct block vector (DBV) chroma reference block.

In some embodiments, the method 900 can further include (i) generating the DBV chroma reference block; and (ii) filtering the DBV chroma reference block by a filter in response to a determination that the one or more of the corresponding luma blocks has been filtered by the filter.

In some embodiments, the pre-determined mode includes an intra-template-matching-prediction (IntraTMP) mode. In some embodiments, the pre-determined mode includes an intra-block-copy (IBC) mode. In some embodiments, the corresponding luma blocks includes a center block, a top-left block, a top-right block, a bottom-left block, and a bottom-right block. In some embodiments, the pre-defined order includes the center block, the top-left block, the top-right block, the bottom-left block, and the bottom-right block. In other embodiments, however, the pre-defined order can be any suitable orders.

In some embodiments, the method 900 can include determining whether a first luma block of the one or more of the corresponding luma blocks is coded with the pre-determined mode. In other words, the method 900 can use the center block, the top-left block, the top-right block, the bottom-left block, or the bottom-right block to determine the pre-determined mode.

In some embodiments, the method 900 can include (i) determining that the partition mode of the current block is a single-tree partition; and (ii) processing the chroma block based on a directed mode (DM). In some embodiments, the method 900 can further include filtering the chroma block by a filter in response to a determination that the one or more of the corresponding luma blocks has been filtered by the filter.

In some embodiments, the pre-determined mode can be a fusion mode, and the fusion mode indicates that “N” original luma blocks are fused to generate the corresponding luma blocks based on pre-defined weights. In such embodiments, the method 900 can further include generating a fused chroma block prediction according to the fusion mode based on the pre-defined weights.

### ADDITIONAL CONSIDERATIONS

The above Detailed Description of examples of the disclosed technology is not intended to be exhaustive or to limit the disclosed technology to the precise form disclosed above. While specific examples for the disclosed technology are described above for illustrative purposes, various equivalent modifications are possible within the scope of the described technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative implementations or sub-combinations. Each of these processes or blocks may be implemented in a variety of different ways. Also, while processes or blocks are at times shown as being performed in series, these processes or blocks may instead be performed or implemented in parallel, or may be performed at different times. Further, any specific numbers noted herein are only examples; alternative implementations may employ differing values or ranges.

In the Detailed Description, numerous specific details are set forth to provide a thorough understanding of the presently described technology. In other implementations, the techniques introduced here can be practiced without these specific details. In other instances, well-known features, such as specific functions or routines, are not described in detail in order to avoid unnecessarily obscuring the present disclosure. References in this description to “an implementation/embodiment,” “one implementation/embodiment,” or the like mean that a particular feature, structure, material, or characteristic being described is included in at least one implementation of the described technology. Thus, the appearances of such phrases in this specification do not necessarily all refer to the same implementation/embodiment. On the other hand, such references are not necessarily mutually exclusive either. Furthermore, the particular features, structures, materials, or characteristics can be combined in any suitable manner in one or more implementations/embodiments. It is to be understood that the various implementations shown in the figures are merely illustrative representations and are not necessarily drawn to scale.

Several details describing structures or processes that are well-known and often associated with communications systems and subsystems, but that can unnecessarily obscure some significant aspects of the disclosed techniques, are not set forth herein for purposes of clarity. Moreover, although the following disclosure sets forth several implementations of different aspects of the present disclosure, several other implementations can have different configurations or different components than those described in this section. Accordingly, the disclosed techniques can have other implementations with additional elements or without several of the elements described below.

Many implementations or aspects of the technology described herein can take the form of computer- or processor-executable instructions, including routines executed by a programmable computer or processor. Those skilled in the relevant art will appreciate that the described techniques can be practiced on computer or processor systems other than those shown and described below. The techniques described herein can be implemented in a special-purpose computer or data processor that is specifically programmed, configured, or constructed to execute one or more of the computer-executable instructions described below. Accordingly, the terms “computer” and “processor” as generally used herein refer to any data processor. Information handled by these computers and processors can be presented at any suitable display medium. Instructions for executing computer- or processor-executable tasks can be stored in or on any suitable computer-readable medium, including hardware, firmware, or a combination of hardware and firmware. Instructions can be contained in any suitable memory device, including, for example, a flash drive and/or other suitable medium.

The term “and/or” in this specification is only an association relationship for describing the associated objects, and indicates that three relationships may exist, for example, A and/or B may indicate the following three cases: A exists separately, both A and B exist, and B exists separately.

These and other changes can be made to the disclosed technology in light of the above Detailed Description. While the Detailed Description describes certain examples of the disclosed technology, as well as the best mode contemplated, the disclosed technology can be practiced in many ways, no matter how detailed the above description appears in text. Details of the system may vary considerably in its specific implementation, while still being encompassed by the technology disclosed herein. As noted above, particular terminology used when describing certain features or aspects of the disclosed technology should not be taken to imply that the terminology is being redefined herein to be restricted to any specific characteristics, features, or aspects of the disclosed technology with which that terminology is associated. Accordingly, the invention is not limited, except as by the appended claims. In general, the terms used in the following claims should not be construed to limit the disclosed technology to the specific examples disclosed in the specification, unless the above Detailed Description section explicitly defines such terms.

A person of ordinary skill in the art may be aware that, in combination with the examples described in the implementations disclosed in this specification, units and algorithm steps may be implemented by electronic hardware, or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this application.

Although certain aspects of the invention are presented below in certain claim forms, the applicant contemplates the various aspects of the invention in any number of claim forms. Accordingly, the applicant reserves the right to pursue additional claims after filing this application to pursue such additional claim forms, in either this application or in a continuing application.

I/We claim:

1. A method for decoding a video, comprising:
determining a partition mode of a current block of the video;
identifying corresponding luma blocks of a current chroma block;
determining whether one or more of the corresponding luma blocks is coded with a pre-determined mode based on a pre-defined order;
in response to a determination that one or more of the corresponding luma blocks is coded with the pre-determined mode, applying the pre-determined mode to the current chroma block.

2. The method of claim 1, further comprising:
determining that the partition mode of the current block is a dual-tree partition; and
processing the chroma block based on a direct block vector (DBV) chroma reference block.

3. The method of claim 2, further comprising:
generating the DBV chroma reference block; and
filtering the DBV chroma reference block by a filter in response to a determination that the one or more of the corresponding luma blocks has been filtered by the filter.

4. The method of claim 1, wherein the pre-determined mode includes an intra-template-matching-prediction (IntraTMP) mode.

5. The method of claim 1, wherein the pre-determined mode includes an intra-block-copy (IBC) mode.

6. The method of claim 1, wherein the corresponding luma blocks includes a center block, a top-left block, a top-right block, a bottom-left block, and a bottom-right block.

7. The method of claim 6, wherein the pre-defined order includes starting from the center block.

8. The method of claim 6, wherein the pre-defined order includes ending with the bottom-right block.

9. The method of claim 6, wherein the pre-defined order includes the center block, the top-left block, the top-right block, the bottom-left block, and the bottom-right block.

10. The method of claim 1, wherein determining whether the one or more of the corresponding luma blocks is coded with the pre-determined mode based on the pre-defined order further comprises:
determining whether a first luma block of the one or more of the corresponding luma blocks is coded with the pre-determined mode.

11. The method of claim 1, further comprising:
determining that the partition mode of the current block is a single-tree partition;
processing the chroma block based on a directed mode (DM).

12. The method of claim 11, further comprising:
filtering the chroma block by a filter in response to a determination that the one or more of the corresponding luma blocks has been filtered by the filter.

13. The method of claim 1, wherein the pre-determined mode is a fusion mode, wherein the fusion mode indicates that “N” original luma blocks are fused to generate the corresponding luma blocks based on pre-defined weights.

14. The method of claim 13, further comprising:
generating a fused chroma block prediction according to the fusion mode based on the pre-defined weights.

15. A method for encoding a video, comprising:
determining that a partition mode of a current block is a dual-tree partition;
identifying corresponding luma blocks of a current chroma block;
determining whether one or more of the corresponding luma blocks is coded with a pre-determined mode based on a pre-defined order;
in response to a determination that one or more of the corresponding luma blocks is coded with the pre-determined mode, applying the pre-determined mode to the chroma block; and
processing the chroma block based on a direct block vector (DBV) chroma reference block.

16. The method of claim 15, wherein the pre-determined mode includes an intra-template-matching-prediction (IntraTMP) mode and an intra-block-copy (IBC) mode.

17. The method of claim 15, wherein the corresponding luma blocks includes a center block, a top-left block, a top-right block, a bottom-left block, and a bottom-right block.

18. The method of claim 17, wherein the pre-defined order includes the center block, the top-left block, the top-right block, the bottom-left block, and the bottom-right block.

19. A non-transitory computer-readable storage medium having a computer program and a bitstream stored thereon, wherein the computer program, when executed by a processor, enables the processor to perform an encoding method to generate the bitstream, the encoding method comprising:
determining that a partition mode of a current block is a dual-tree partition;
identifying corresponding luma blocks of a current chroma block;
determining whether one or more of the corresponding luma blocks is coded with a pre-determined mode based on a pre-defined order;
in response to a determination that one or more of the corresponding luma blocks is coded with the pre-determined mode, applying the pre-determined mode to the chroma block; and
processing the chroma block based on a direct block vector (DBV) chroma reference block.

20. The non-transitory computer-readable storage medium of claim 19, wherein the pre-determined mode includes an intra-template-matching-prediction (IntraTMP) mode and an intra-block-copy (IBC) mode.
